(19) United States
(12) Patent Application Publication
(10) Pub. No.: US 2018/0120411 A1
(43) Pub. Date: May 3, 2018

(54) LOCATING A KEY

(71) Applicant: Continental Automotive GmbH, Hannover (DE)

(72) Inventor: Stefan Hermann, Neunkirchen am Brand (DE)

(21) Appl. No.: 15/572,447

(22) PCT Filed: Apr. 7, 2016
(86) PCT No.: PCT/EP2016/057657

§ 371 Date: Nov. 7, 2017

(30) Foreign Application Priority Data
May 8, 2015 (DE) 10 2015 208 620.8

(51) Int. Cl. G01S 5/02; B60R 25/20; B60R 25/24

(52) U.S. Cl. CPC G01S 5/0252; B60R 25/245; B60R 25/209

(57) ABSTRACT

The application relates to methods and a locating device with a plurality of locating modules (1, 2, 3, 4, 5) for locating a key (51, 52), in particular a key for a motor vehicle (80), characterized in that the locating device has at least one measuring device to measure the field strength (F1, F2, F3, F4, F5, F6) of at least one HF signal (F1, F2, F3, F4, F5, F6) transmitted by a locating module (1, 2, 3, 4, 5) in the motor vehicle or in the key (51, 52) and received by a further locating module (1, 2, 3, 4, 5) in the key (51, 52) or in the vehicle, in particular with a filtering and/or averaging of recorded RSSI values.

The invention relates to a method and devices for locating a key, in particular by means of an HF radio link for passive access systems for a motor vehicle.

A number of approaches for locating a key for a motor vehicle already exist per se, such as, for example, in DE10032936A1, DE102012201385A1, WO2012076389A1.

One object of the invention is to optimize a locating device for a key for, in particular, a motor vehicle. The object is achieved in each case by the subject-matter of the independent patent claims. Some particularly advantageous designs of the invention are indicated in the subclaims and the description. Designs of the invention may also enable an efficient and/or low-cost location as alternatives to existing solutions. According to designs of the invention, a location of a key (for a motor vehicle) on the basis of (the field strength of) at least one HF or RF signal of a key may also advantageously, for example, dispense with an evaluation of an LF signal.

Further features and advantages of some advantageous designs of the invention are set out in the following description of a number of example embodiments of the invention with reference to the drawing.

The figures in each case illustrate some of the possible designs of the invention in simplifying and schematic form, wherein:

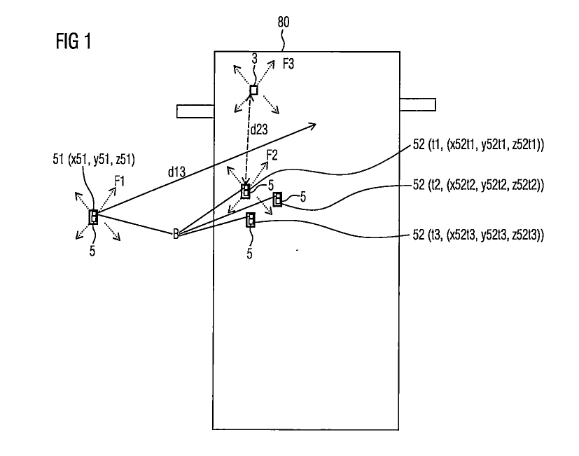

FIG. 1 shows a vehicle with a locating device with a transmitter and a receiver to locate a key,

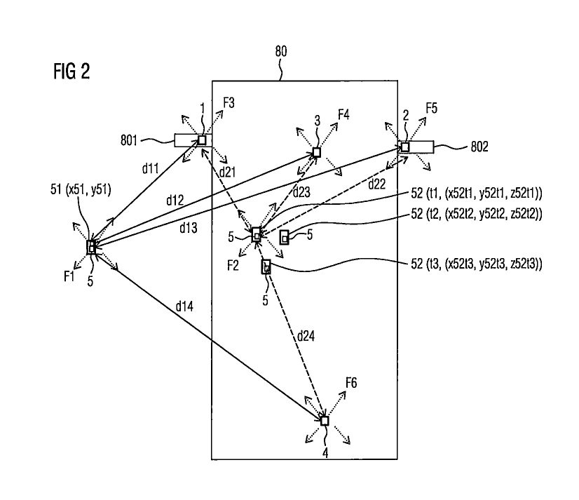

FIG. 2 shows a vehicle with a locating device with a plurality of transmitters and/or a plurality of receivers to locate a key,

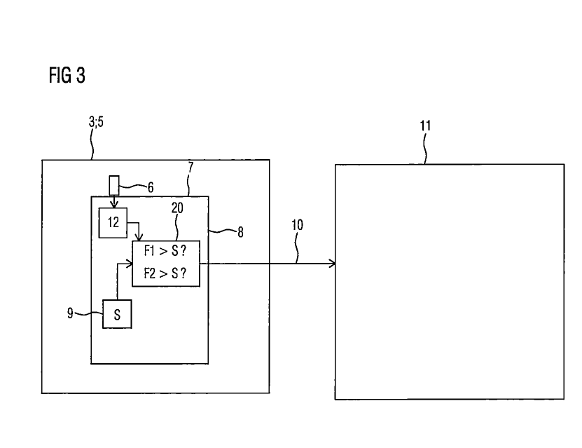

FIG. 3 shows a locating module with a receiver and an evaluation device of a locating device in a key or vehicle (to locate a key in relation to a motor vehicle),

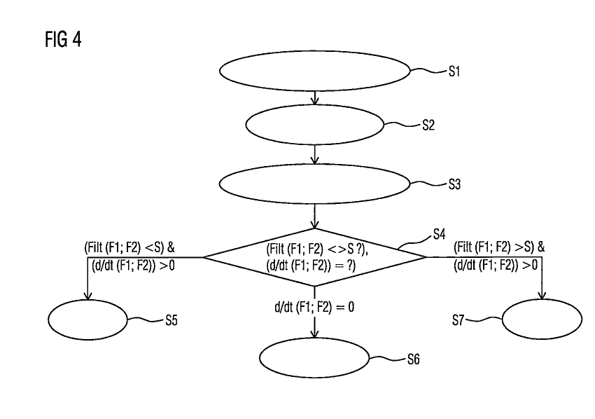

FIG. 4 shows a sequence of a location of a key,

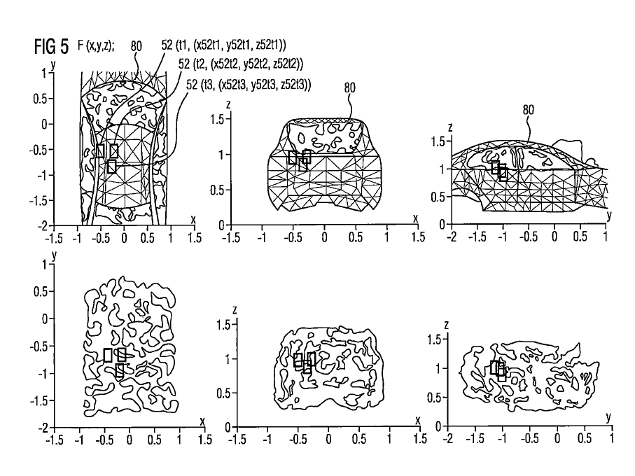

FIG. 5 shows some examples of spatial characteristics of field strengths in the vicinity of an automobile.

FIG. 1 shows, as an example of designs of the invention, a locating module 3 of a locating device, said locating module 3 being located in a motor vehicle 80, e.g. inside the passenger compartment of a motor vehicle 80, e.g. in the general vicinity of a car radio, etc.,

and also schematically a locating module 5 of a locating device which is located in a key 51 outside or in a key 52 inside the motor vehicle 80.

At least one locating module 3 or 5 is intended to determine, on the basis of at least one field strength measured by it of at least one (HF and/or RF) field F1, F2, F3, F4, F5, F6 transmitted by the key 51 or 52 or by a locating module in the motor vehicle 80,

whether the key 51 (transmitting a field F1 or receiving a field F3 for the location in FIG. 1) is located outside the (passenger compartment) of the motor vehicle 80,
or whether the key F2 (transmitting a field F2 or receiving a field F3 for the location in FIG. 1) is located inside the (passenger compartment of the) motor vehicle 80,
e.g. by analyzing one or, in particular, a plurality of (temporarily stored) measured values of the field strength F1, F2; F3, F4, F5, F6, e.g. with a characteristic analysis (d/dt) and/or with a temporal low-pass filtering and/or with threshold values (d/dt), etc.

On the basis of the decision of the locating device or one of its locating modules 3 or 5 (as to whether a key 51 or 52 is located outside or inside the (passenger compartment of the) vehicle 80),

a device (11 in FIG. 3) can be informed and can make decisions on the basis thereof, e.g. whether a starting/switching on of the engine of the motor vehicle 8 is allowed and/or initiated, whether an opening of a door of the motor vehicle is allowed and/or initiated, etc.

In FIG. 1, a key 51 is located outside a motor vehicle, this being determinable on the basis of measured field strengths and/or temporal and/or spatial characteristics of HF signals received in at least one locating module;

and a key 52 is located at three times t1, t2, t3 at three positions ((x52t1, y52t1, z52t1) and (x52t2, y52t2, z52t2) and (x52t3, y52t3, z52t3)) inside a motor vehicle 80, this being determinable on the basis of (as FIG. 5 shows, different) field strengths measured at the times t1, t2, t3 and at the positions ((x52t1, y52t1, z52t1) and (x52t2, y52t2, z52t2) and (x52t3, y52t3, z52t3)) and/or characteristics (because the key is located at different locations at the three times t1, t2, t3) of HF signals received in at least one locating module 3 or 5.

FIG. 2 shows, as an example of a further design of the invention,

a plurality of locating modules 1, 2, 3, 4; 5 of a locating system of which one or more (1, 2, 3, 4) of said locating modules 1, 2, 3, 4, 5 is located in a motor vehicle 80 and one (5) is located in the key 51 or 52,
e.g. with locating modules 3, 4 inside the passenger compartment of a motor vehicle 80 and/or with locating modules 1, 2 outside the (passenger compartment of a) motor vehicle 80 in each case in one of the wing mirrors 801, 802 and/or bumpers and/or engine compartment, etc.

The locating modules 1, 2, 3, 4 of the locating device in the motor vehicle 80 can also be connected via a cable or and/or via a radio link to one another and/or to an evaluation device for an exchange of measurement results relating to field strengths.

A locating module 3 or 5 which evaluates and/or analyzes measured (e.g. low-pass-filtered) field strengths and/or makes decisions may be disposed e.g. in the motor vehicle 80 and/or in the key 51, 52; it can also notify a decision to a different locating module or to a controller, e.g. via an (e.g. HF) radio link.

The frequency of a field F1, F2, F3, F3; F5, F6 which a locating module 5 in the key 51, 52 and/or (at least) one locating module 1, 2, 3, 4 in the motor vehicle 80 transmits is, in particular a high frequency (e.g. also referred to as RF or radio frequency), e.g. an HF frequency and/or RF frequency and/or frequency above 300 kHz, in particular in a band around 900 MHz or 2.4 GHz (Bluetooth). Correspondingly, a receiving device and/or a filter, etc., can be provided (in each case) in a locating module 1, 2, 3, 4, 5, 6 of the locating device for reception in this frequency range; a decision (as to whether a key 51 or 52 is located inside or outside a passenger compartment of a vehicle 80) can be made in general or for or in one specific key (e.g. further identified on the basis of identification signals) on the basis of received field strength(s) in this frequency range.

A measuring device 12 may, in particular, be a measuring device for an HF frequency and/or RF frequency and/or frequency above 300 kHz, in particular in a band around 900 MHz or 2.4 GHz (Bluetooth). A location of a key (for a motor vehicle) can advantageously dispense e.g. with an evaluation of an LF signal and therefore with the generation thereof on the basis of (the field strength of) at least one HF or RF signal from a locating module 1, 2, 3, 4; 5. With regard to a measurement of the field strength F1, F2, F3, F4, F5, F6, an (e.g. measurable) RF RSSI or RSSI value of at least one received HF signal can be provided.

A data exchange, e.g. relating e.g. to the location between a locating module 1, 2, 3, 4, 5 of the locating device e.g. in a key 51, 52 or in the motor vehicle 80 and a further locating module 1, 2, 3, 4, 5 of the locating device e.g. in a key 51 or 52 or in the motor vehicle 80 can be carried out e.g. via a radio link via an HF frequency and/or RF frequency and/or frequency above 300 kHz, in particular in a band around 900 MHz or 2.4 GHz (Bluetooth).

Different technologies can be used as an HF link. An HF link may, for example, be a sub-GHz link and/or a link in one or more ISM bands and/or a Bluetooth (e.g. Bluetooth Low Energy) link. In particular, but not only in the case of an HF link in the form of a Bluetooth link, the key 51; 52 may also be a Smartphone. The key 51; 52 may generally be any key for a motor vehicle 80, e.g. in the form of a card and/or a Smartphone and/or with a mechanical key and/or with a receiver and/or transmitter for e.g. at least one key ID also.

Only at least one HF connection (or RF connection) can be provided or evaluated, i.e. without taking account or using an LF link (e.g. to the key).

FIG. 3 shows, schematically and in simplifying form, an example of a locating module 3 of a locating system 1, 2, 3, 4, 5 with an antenna 6 for receiving a field F1, F2; F3, F4, F5, F6 transmitted from or to e.g. a key 51 located at a position, wherein the field strength (measured with a measuring device 12) of the (possibly entire) field F(x,y,z) can be evaluated (20) with an evaluation device 7 (e.g. on a printed circuit board, etc., with a controller and/or circuit) at the location of the locating module 3 or 5 of a locating system at one or more times using e.g. at least one threshold value S (e.g. stored in a memory 9 in the evaluation device) (and/or temporal characteristics, low-pass filtering, averaging, etc.). The evaluation device 7 transfers a result 10 herefrom e.g. to a device 11.

The device 11 (e.g. a motor vehicle locking device or door-locking device, etc.) can allow and/or initiate e.g. a starting/switching on of the engine of the motor vehicle 8 depending on a signaled (10) decision of the evaluation device notified to it by a locating module 3 or 5 in the motor vehicle 80 or key 51, 52, or allow and/or initiate an opening of a door of the motor vehicle, etc.

For example, the device 11 (e.g. a motor vehicle locking device or door-locking device, etc.), if the evaluation device 7 indicates to it as a decision (10) that a key 51 is located at (e.g. any) position (x51, y51, z51) outside the motor vehicle 80, can allow and/or initiate or prevent a starting/switching on of the engine of the motor vehicle 80 and/or allow and/or initiate an opening of a door of a motor vehicle or prevent it (e.g. if a measured field strength is below a threshold and therefore the distance d13 between the key 51 and the motor vehicle 80 is too great).

For example, the device 11 (e.g. a motor vehicle locking device or door-locking device, etc.), if the evaluation device 7 indicates to it as a decision (10) that a key 52 is located at (e.g. any) position (x52, y52) inside the motor vehicle 80, can furthermore allow and/or initiate or prevent e.g. a starting/switching on of the engine of the motor vehicle 80 and/or allow or prevent an opening or locking of a door of the motor vehicle.

An evaluation device of a locating device may be disposed e.g. in (only or at least) one of the locating modules 1, 2, 3, 4, 5 which in each case measure a field strength of at least one (or of an entire) field F1, F2, F3, F4; F5, F6 (and indicate it to the evaluation device), or in a further locating module of the locating device, e.g. also in a module in/on the car radio, etc.

A field F1, F2, F3, F4, F5, F6 of an HF signal of a key 51 or 52 or locating module 1, 2, 3, 4 received (in each case) at a locating module 1, 2, 3, 4 can be evaluated by the motor vehicle 80 in different ways, e.g. at least one measured field strength of the field F(x, y) can be analyzed at the location of (at least) one locating module 1, 2, 3, 4; 5 of the locating system at one or more times or through comparison with stored temporal characteristics, or with trajectory analyses or through derivation, etc. for a decision of the decision device 8.

If a decision device 8 for locating a key 51; 52 performs an analysis (e.g. through comparison or mean value comparison) of a plurality of field strengths, determined with at least one measuring device 12 at a plurality of times, of at least one received HF signal F1, F2, F3, F4; F5; F6 (i.e., for example, a signal characteristic) transmitted by a key 51; 52 or locating module 1, 2, 3, 4 in the motor vehicle 80 with at least one threshold value S, etc., field strengths of one or more HF signals F1, F2, F3, F4; F5; F6 measured for a dynamic location of this type can be temporarily stored in a memory 9 of a module of the locating device 3 or 5.

The field strength of (at least) one signal F1; F2, F3, F4; F5, F6 transmitted by a locating module 1, 2, 3, 4 in the motor vehicle 80 or (5) in the key 51; 52 may decrease e.g. approximately quadratically with the distance between a receiver 1/2/3/4 of the signal F1, F2, F3, F4; F5; F6 and the locating module 5; 1, 2, 3, 4 and/or may have different characteristics at obstacles.

For example, the distance d11, d12, d13, d14 between this receiver 1/2/3/4 and the key 51 or locating module 1, 2, 3, 4 in the motor vehicle 80 transmitting the signal F1 or the current position of the receiver can be inferred in each case from the field strength of a signal received at a receiver at a locating module 1/2/3/4/5. The distance d21, d22, d23, d24 between this receiver 1/2/3/4 and the key 52 or locating module 1, 2, 3, 4 in the motor vehicle 80 transmitting this signal F2 can also be inferred in each case from the field strength F2 of a signal received at a receiver at a locating module 1/2/3/4/5.

The last (e.g. t3) position of a locating module (e.g. the last position of the key in the motor vehicle) can also be (dynamically) inferred from (e.g. RSSI) field strengths of a plurality of signals received at a plurality of times t1, t2, t3 (and therefore at different positions ((x52t1, y52t1, z52t1) and (x52t2, y52t2, z52t2) and (x52t3, y52t3, z52t3))) at a receiver at a locating module 1/2/3/4/5, e.g. with a low-pass filtering or averaging, etc.

If a plurality of receivers at a locating module 1/2/3/4 in each case receive one or more signals, the signals can be jointly evaluated.

For example, for the position x51, y51 of the key 51 shown in FIG. 1 and FIG. 2, a decision is made that the key 51 is located outside the motor vehicle 80, and/or for the positions ((x52t1, y52t1, z52t1) and (x52t2, y52t2, z52t2) and (x52t3, y52t3, z52t3)) of the key 52 at the times t1, t2, t3, a decision is made that the key 52 is located last (e.g. temporally after t3) inside the motor vehicle 80 (i.e., in particular, inside the passenger compartment of the vehicle 80).

FIG. 4 shows by way of example a sequence of a location S1-S7 of a key 51 or 52. (52 may possibly also be the same key as the key at the position 51 but at a different time, or a further key.)

In FIG. 4, in step S1, a polling in an access zone is started by a decision device, i.e. a key 51; 52 is prompted e.g. by a radio signal (e.g. from at least one locating module 1, 2, 3, 4 of the locating device in the motor vehicle 80) to transmit (at least) one HF signal or to receive an HF signal (from the motor vehicle 80), and/or at least one locating module 1, 2, 3, 4 in the motor vehicle 80 is prompted to transmit an HF signal or receive an HF signal (from the key).

In step S2, field strengths of one or more HF signals received with at least one antenna, here at a plurality of times t1, t2, t3 (and therefore at different positions ((x52t1, y52t1, z52t1) and (x52t2, y52t2, z52t2) and (x52t3, y52t3, z52t3)), here in the form of RF-RSSI or HF-RSSI values, are measured here by a measuring device at a plurality of times t1, t2, t3 etc. (and are temporarily stored e.g. in a memory).

In step S3, RF-RSSI or HF-RSSI values measured here at a plurality of times t1, t2, t3 (and therefore at different positions ((x52t1, y52t1, z52t1) and (x52t2, y52t2, z52t2) and (x52t3, y52t3, z52t3)) and relating to field strengths, measured with a measuring device, of one or more HF signals received with at least one antenna are evaluated here, i.e., for example, are filtered (e.g. with a low-pass filter TP or LP) and/or differentiated.

In step S4, a decision relating to a location of a key 52; 53 is made by a decision device on the basis of the RF-RSSI or HF-RSSI values measured here at different times t1, t2, t3 (and therefore at different positions ((x52t1, y52t1, z52t1) and (x52t2, y52t2, z52t2) and (x52t3, y52t3, z52t3)) (and analyzed in step S3) and, where appropriate, on the basis of analyses.

If e.g. here at a plurality of times t1, t2, t3 (and therefore at different positions ((x52t1, y52t1, z52t1) and (x52t2, y52t2, z52t2) and (x52t3, y52t3, z52t3)) received and then filtered RF-RSSI or HF-RSSI values (all or predominantly or on average or low-pass filtered, etc.) are below a stored threshold (possibly under further condition(s) that e.g. a (possibly averaged) temporal derivation is furthermore greater than zero), a decision device can decide, in step S5, to transmit a signal (10 in FIG. 3) to a further device (11 in FIG. 3), indicating that the key (51, 51 in FIG. 1, 2) is located outside (e.g. the passenger compartment of the) motor vehicle (80 in FIG. 1, 2) (e.g. as flag “loc_flag ID outside”).

If e.g. filtered RF-RSSI or HF-RSSI values (all or predominantly or on average, etc.) e.g. here at a plurality of times t1, t2, t3 (and therefore at different positions ((x52t1, y52t1, z52t1) and (x52t2, y52t2, z52t2) and (x52t3, y52t3, z52t3)) or their mean value or low-pass filtering, etc. correspond precisely or sufficiently precisely to the last value or (sample/) set of values and/or if the RF-RSSI or HF-RSSI values in differentiated (temporally derived) form precisely or (according to a specification) sufficiently precisely produce zero (because they do not change or hardly change),

a decision device can decide, in step S6, to retain the last decision concerning where the key 51; 52 was and/or to transmit a signal (10 in FIG. 3) to a further device (11 in FIG. 3), indicating that the last decision concerning where the key 51; 52 was (inside or outside (e.g. the passenger compartment) of the motor vehicle) is retained.

If e.g. filtered RF-RSSI or HF-RSSI values (all or predominantly or on average, etc.) e.g. here at a plurality of times t1, t2, t3 (and therefore at different positions ((x52t1, y52t1, z52t1) and (x52t2, y52t2, z52t2) and (x52t3, y52t3, z52t3)) are on or above a stored threshold value (possibly with the further condition that RSSI values (possibly after averaging) in differentiated (derived) form are not equal to zero), a decision device can decide, in step S7, to transmit a signal (10 in FIG. 3) to a further device (11 in FIG. 3), indicating that the key (51; 52 in FIG. 1, 2) is inside (e.g. the passenger compartment) of the motor vehicle (80 in FIG. 1, 2) (e.g. as flag “loc_flag ID inside”).

In order to locate a key (51; 52), a decision device 8 can at least also take into account an analysis of an acceleration of the object to be located (51; 52) measured in the object to be located, in particular the key (51; 52), e.g. with acceleration sensors B in the object to be located 51; 52 which (B) forward data relating to an acceleration recorded by them (B) to the decision device 8 (in the object or in the motor vehicle) e.g. via the (e.g. HF) radio interface, e.g. for (improved) determination of small location changes in the motor vehicle, etc.

FIG. 5 shows some examples of spatial characteristics of field strengths F (of signals transmitted by locating modules 1, 2, 3, 4 or 5 in the vicinity of motor vehicles 80, top left in a plan view from above of a motor vehicle 8080, top middle a view from behind of a tailgate of a motor vehicle 80, top right a view from one side of one side of a motor vehicle 80, top left in a plan view from above of a motor vehicle 80 (without showing the motor vehicle), top middle a view from behind of a tailgate of a motor vehicle 80 (without showing the motor vehicle), top right a view from one side of one side of a motor vehicle 80 (without showing the motor vehicle).

By way of example, FIG. 5 in each case shows examples of spatial characteristics of field strengths F (i.e. field strengths F(x,y) with indications of scale, upwards and to the right in each case in meters in directions (to the right) x and (upwards) y and (to the front/back in the motor vehicle 80) z. Possibly in some applications or configurations, spatially and/or temporally irregular characteristics of field strengths F(x,y) may render advantageous spatially and/or temporally multiple measurements and evaluations of field strengths F by (as in FIG. 1) one or (as in FIG. 2) more locating device modules at 1, 2, 3, 4 of a locating device (e.g. connected to an evaluation device via a cable and/or via a radio link).

FIG. 5 contains e.g. a key 52 at three times t1, t2, t3 in succession at the plurality (here three) of locations ((x52t1, y52t1, z52t1) and (x52t2, y52t2, z52t2) and (x52t3, y52t3, z52t3)) inside the vehicle 80, at which locations (and times) the field strength of a plurality of HF signals F1, F2, F3, F4 is in each case determined.

### REFERENCE NUMBER LIST

1 Locating module of a locating system (in or on the motor vehicle)
2 Locating module of a locating system (in or on the motor vehicle)
3 Locating module of a locating system (in or on the motor vehicle)
4 Locating module of a locating system (in or on the motor vehicle)
5 Locating module of a locating system (alternative in the key)
51 Key
52 Key
6 Antenna on a locating module 1/2/3/4
7 Evaluation device/printed circuit board
8 Decision device (F1/2>S?)
9 Memory for threshold value(s) S
10 Result of a comparison (F1/2>S?, characteristics d/dt, etc.)
11 Device (motor vehicle locking device, etc.)
12 Measuring device (in 1, 2, 3, 4 for measuring F1 and F2)
13 Comparison device (F1/2>S?, characteristics d/dt, etc.)
80 Motor vehicle
801 Rearview mirror (of 80)
802 Rearview mirror (of 80)
S Threshold value of received field strength(s), for assumption key in the motor vehicle
(x51, y51) Position of a key 51
(x52, y52) Position of a key 52
F1 Field, transmitted by the key S1
F1 (x, y) Field at the position (x, y), transmitted by the key 1
F2 Field, transmitted by the key S2
F2 (x, y) Field at the position (x, y), transmitted by the key S2
F3, F4, F5, F6 Fields, transmitted by locating modules 1, 2, 3, 4 in 80
S1 Step of starting the polling (in the access zone)
S2 Step of receiving HF-RSSI values
S3 Step of filtering and/or differentiating HF-RSSI values
S4 Step of deciding whether key inside or outside
S5 Step of deciding and/or signaling that key inside
S6 Step of deciding and/or signaling that key is where it was previously (either as previously outside or as previously inside)
S7 Step of deciding and/or signaling that key outside
B Acceleration sensors (in the object)

1. A locating device with a plurality of locating modules for locating a key
for a motor vehicle,
the locating device comprising:
at least one measuring device configured to measure the field strength of at least one high frequency signal transmitted by a first locating module comprised in at least one of the motor vehicle and the key, and received by a second locating module comprised in at least one of the key and the vehicle, the first and second locating modules comprised in the plurality of locating modules.

2. The locating device as claimed in claim 1, wherein
precisely one locating module is configured to be disposed in a motor vehicle, said locating module at least one of transmitting a high frequency signal to a key
and receiving the high frequency signal from the key.

3. The locating device as claimed in claim 1, wherein
the plurality of locating modules are configured to be disposed in a motor vehicle,
and further configured to at least one of transmit a high frequency signal to a key,
and receive a high frequency signal from the key.

4. The locating device as claimed in claim 1, wherein
the at least one measuring device is comprised in at least one of the plurality of locating modules of the locating device in one of the key and the motor vehicle, wherein the one or more measuring devices is configured to measure the field strength of at least one received high frequency signal.

5. The locating device as claimed in claim 1, wherein
the at least one measuring device is configured to measure the field strength in the form of an RF_RSSI or RSSI value of at least one transmitted high frequency signal being received by at least one locating device.

6. The locating device as claimed in claim 1, further comprising:
a decision device configured to locate a key at least on the basis of an analysis of one of a temporal and spatial characteristic; of a field strength of an high frequency signal.

7. The locating device as claimed in claim 1, further comprising:
a decision device which is designed to locate a key at least on the basis of an analysis through low-pass filtering of a plurality of field strengths of an high frequency signal received in a locating module, said field strengths being determined at different times (t1, t2, t3) and at different positions.

8. The locating device as claimed in claim 1, further comprising:
a decision device configured to locate a key at least on the basis of an analysis of a plurality of field strengths of an high frequency signal measured with at least one measuring device in the key at a plurality of times and at a plurality of positions at which the key is successively located.

9. The locating device as claimed in claim 1, further comprising:
a decision device configured to locate a key at least on the basis of a comparison of the temporal derivation of a plurality of field strengths of at least one high frequency signal determined with at least one measuring device at a plurality of times with at least one threshold value of zero.

10. The locating device as claimed in claim 1, further comprising:
a decision device configured to, with a temporal derivation of a plurality of field strengths, determined with at least one measuring device at a plurality of times, of at least one high frequency signal received or transmitted by a key at at least one of a plurality of times and a plurality of locations, close to a threshold value of zero,
decide to retain the last result of the decision device when the key is assumed to be one of still located outside the vehicle and still located inside the vehicle.

11. The locating device as claimed in claim 1, further comprising:
a decision device configured to, with a predefined value of zero
of at least one field strength of at least one high frequency signal determined at at least one of a plurality of times and a plurality of locations at which the key is successively located, to device at least one of
that no key located inside the vehicle, and
that no key is located outside the vehicle in the vicinity of the vehicle.

12. The locating device as claimed in claim 1, further comprising:
at least one of an engine starter controller and a door opener controller configured to decide, on the basis of a location of the key, whether the key is located inside or outside a vehicle,
via at least one of an initiation, execution and authorization of at least one of starting of the engine of the motor vehicle and an opening of a door of the motor vehicle.

13. The locating device as claimed in claim 1, wherein the at least one measured high frequency signal for locating a key has a frequency in at least one of the range about 300 kHz, a band around 900 MHz, and a band around 2.4 GHz.

14. The locating device as claimed in claim 1, further comprising:
a decision device configured to locate an object by analyzing acceleration of the object to be located as measured in the object to be located.

15. A method for locating a key for a motor vehicle with a locating device comprising:
at the locating device, taking account of at least one field strength of high frequency signals measured with at least one locating module of the locating device at at least one of a plurality of times and at a plurality of locations at which the key is successively located without using low-frequency signals transmitted by a key for the location.
